(19) United States
(12) Patent Application Publication
(10) Pub. No.: US 2007/0139450 A1
(43) Pub. Date: Jun. 21, 2007

(54) Method and apparatus for rendering smooth teletext graphics

(75) Inventors: Gerard De Haan, Eindhoven (NL); Paul Michiel Hofman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkijkle Phillips Electronics N.V.

(21) Appl. No.: 10/577,097

(22) PCT Filed: Oct. 20, 2004
(86) PCT No.: PCT/IB04/03470

§ 371 Date: Apr. 25, 2006

(30) Foreign Application Priority Data
Oct. 29, 2003 (EP) 0330183.5

(51) Int. Cl. G09G 5/02

(52) U.S. Cl. 345/698

(57) ABSTRACT

Method for rendering smooth teletext graphics, when an input teletext page (D1) is to be displayed at a target resolution on a device. The method comprises the steps of:—separating (100) non-text information and text information composing the input teletext page (D1) in order to give as output an intermediate non-text bitmap (D5) at an intermediate resolution and a final text bitmap (D4) at said target resolution;—scaling up (200) the intermediate non-text bitmap (D5) to obtain a final non-text bitmap (D7) at said target resolution, using an advanced up-scaling algorithm; and,—merging (300) the final non-text bitmap (D7) and the final text bitmap (D4) in order to give an output of a rendered bitmap (D) having the target resolution.

### FIELD OF THE INVENTION

The present invention relates to a method and an apparatus for rendering smooth teletext graphics. More particularly, the present invention relates to a method allowing adaptation of the teletext graphics to the display capabilities of a particular screen.

Teletext format defines a teletext page by means of an alphanumeric matrix of 40×25 characters. Each character is defined by three identifiers:
a number identifying a specific symbol;
a foreground color; and;
a background color.

The typical resolution of a character is a 10×12 array of pixels. Thus, when the teletext page is displayed on a device dedicated to teletext format, the typical or full resolution of the corresponding teletext bitmap is 400×300 pixels.

The symbol may refer to a text item, e.g. a letter, as can be seen in FIG. 1 of the accompanying drawings. When it is displayed, the text item uses the full resolution of 10×12. Thus the corresponding text bitmap is displayed at the full 400×300 resolution.

The symbol may alternatively refer to a non-text item. A non-text item is a ‘checkerboard’ of 2×3 blocks constituting the elementary part of a teletext graphic. An example of such a ‘checkerboard’ can be seen in FIG. 2. When a non-text item, i.e. checkerboard, is displayed, each block has a typical resolution of 5×4 pixels. Thus, the information available in a non-text bitmap corresponds to an intermediate 80×75 resolution which is further rendered as if it is scaled up to the full resolution by pixel repetition. This leads to a coarse resolution for the graphical part of the teletext page.

Through this example, even in the case of a device dedicated to display teletext, it can be seen that graphical content of a teletext page does not use the full capabilities, i.e. resolution, of the screen. This problem is even more acute when the teletext page is displayed on a screen having a higher resolution such as High-Definition TV sets. With the spreading use of the latter type of TV set, it is necessary, for the convenience of the user, to adapt the teletext graphics to the screen capabilities.

### BACKGROUND OF THE INVENTION

Document US 2002/0163501 discloses a method and a device to scale up primary video composed of objects of a smaller format. This method is based on the fact that the video is composed of two sets of distinct data relating to video frames and 2D graphic elements, respectively. Separate and parallel processes are performed on video frame and 2D graphic elements: the first process consists of generating rendered frames from said primary video frames, said rendered frames being scaled up afterwards to the desired output video format; the second process consists of directly rendering the 2D graphic elements in said output video format by using a drawing algorithm ensuring that no degradation of said 2D graphic elements will take place. In a final step, rendered 2D graphic elements are mapped on the up-scaled video frames.

The teaching of this document does not relate to teletext format. In addition, the 2D graphic elements may contain text and non-text information as defined above.

### SUMMARY OF THE INVENTION

It is an object of the present invention to propose a method and an apparatus for rendering smooth teletext graphics.

According to the invention the method for rendering smooth teletext graphics when an input teletext page is to be displayed at a target resolution on a device, is characterized in that it comprises the steps of:
separating non-text information and text information composing the input teletext page in order to give, as output an intermediate non-text bitmap at an intermediate resolution and a final text bitmap at said target resolution;
scaling up the intermediate non-text bitmap to obtain a final non-text bitmap at said target resolution, using an advanced up-scaling algorithm; and;
merging the final non-text bitmap and the final text bitmap in order to give an output of a rendered bitmap having the target resolution.

In a first embodiment, the step of scaling up said intermediate non-text bitmap comprises the sub-steps of:
obtaining a luminance plane from said intermediate non-text bitmap;
scaling up to said target resolution said luminance plane in order to get an up-scaled luminance plane, using said advanced up-scaling algorithm; and,
mapping each pixel of said up-scaled luminance plane with one color identifier of a plurality of color identifiers in order to obtain said final non-text bitmap.

In the first embodiment, said mapping sub-step preferably uses said intermediate non-text bitmap as an input for improving the mapping process.

In a second embodiment, the step of scaling up said intermediate non-text bitmap comprises the sub-steps of:
separating said intermediate non-text bitmap into a plurality of color planes;
scaling up separately to said target resolution each color plane of said plurality of color planes to obtain a plurality of up-scaled color planes, using said advanced up-scaling algorithm; and;
merging said plurality of up-scaled color planes in order to obtain said final non-text bitmap.

Furthermore, the second embodiment preferably comprises the sub-step of scaling up classically said intermediate non-text bitmap in order to obtain a classical up-scaled non-text bitmap having said target resolution by using a classical up-scaling algorithm based on pixel repetition, and said merging sub-step uses said classical up-scaled non-text bitmap as an input for improving the merging process.

The separating step may comprise the sub-steps of:
filtering said input teletext page into a non-text item and a text item;
rendering said non-text item into said intermediate non-text bitmap at said intermediary resolution; and;
rendering said text item into said final text bitmap at said target resolution.

Said separating step may comprise the sub-steps of:
converting said input teletext page into an initial teletext bitmap having the target resolution;
filtering said initial teletext bitmap into a initial non-text bitmap and a final text bitmap; and,
downscaling said initial non-text bitmap from said target resolution to said intermediate resolution in order to give an output of said intermediate non-text bitmap.

According to the invention, the apparatus for rendering smooth teletext graphics when an input teletext page is to be displayed at a target resolution on a device, is characterized in that it comprises:
separation means for separating the input teletext page into an intermediate non-text bitmap at an intermediate resolution and a final text bitmap at said target resolution;
up-scaling means, using an advanced up-scaling algorithm for scaling up said intermediate non-text bitmap from the intermediate resolution to said target resolution, and giving an output of a final non-text bitmap;
merging means for merging said final non-text bitmap from said up-scaling means with said final text bitmap from said separation means in order to give an output of a rendered bitmap at said target resolution.

In a first embodiment of the apparatus, said up-scaling means comprises:
luminance means for obtaining a luminance plane from said intermediate non-text bitmap;
advanced up-scaling means based on an advanced up-scaling algorithm for up-scaling to said target resolution said luminance plane given by said luminance means; and,
mapping means for mapping each pixel of the up-scaled luminance plane given by said advanced up-scaling means with one color identifier of a plurality of color identifiers in order to obtain said final non-text bitmap.

In a second embodiment of the apparatus, the up-scaling means comprises:
color separation means for separating said intermediate non-text bitmap into a plurality of color planes;
advanced up-scaling means based on an advanced up-scaling algorithm for separately up-scaling to said target resolution each color plane of said plurality of color planes; and,
merging means allowing merging of the plurality of up-scaled color planes given by said advanced up-scaling means to calculate said final non-text bitmap.

### BRIEF DESCRIPTION OF THE DRAWINGS

The invention will be better understood and its other aims, details features and advantages will be clearly shown with reference to the following description of a particular embodiment of the invention, given only for illustrative and non-limitative purposes, in connection with the accompanying drawings, in which:

FIG. 1 shows a text item displayed with the typical full resolution of 10×12 pixels;

FIG. 2 shows a non-text item composed of 2×3 blocks displayed at the same resolution as FIG. 1;

FIG. 3 is a flow chart of a first embodiment of the method according to the invention;

FIG. 4 is a detailed flow chart of another embodiment of the advanced up-scaling step;

FIG. 5 is a flow chart of another embodiment of the method according to the invention;

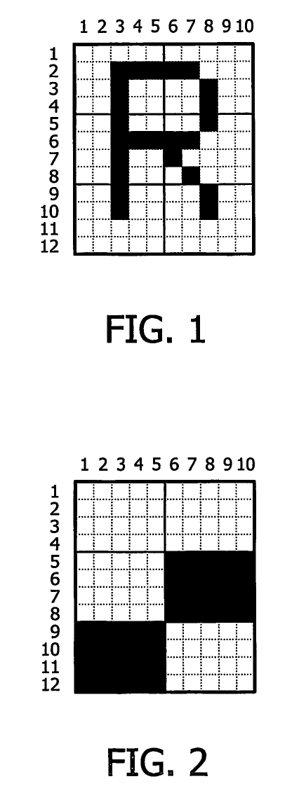

### DESCRIPTION OF PREFERRED EMBODIMENTS

The method of the invention consists in separating a non-text item (i.e. graphics) from a text item of an input teletext page, and then scaling up the non-text item at a target resolution.

In the following description, the target resolution is the 400×300 typical teletext resolution. In other applications of the invention, the target resolution may even be the resolution of the screen on which the teletext page is displayed, for example, the particular resolution of the HDTV set used to display the teletext page.

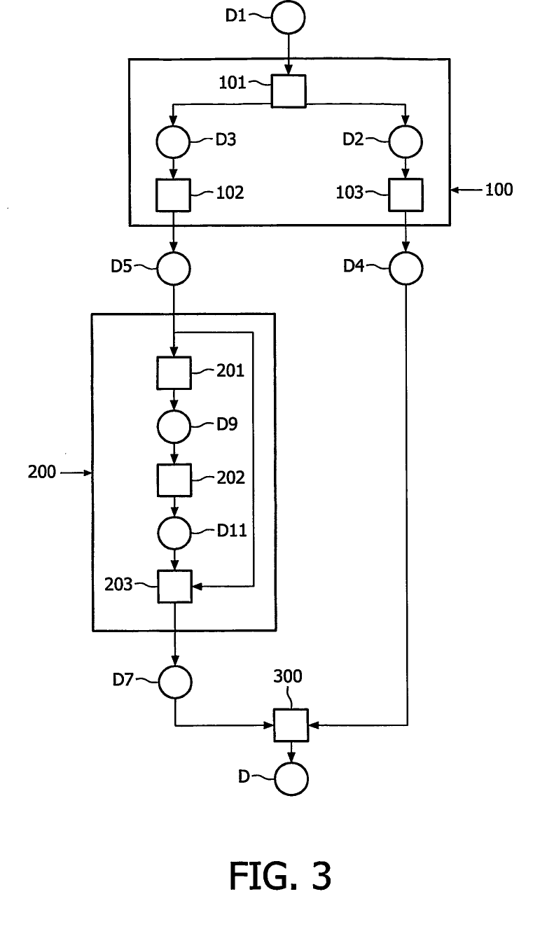

Referring now to FIG. 3, the input of the first embodiment of the method according to the invention is constituted by a raw teletext page, D1.

The separation step 100 comprises the following sub-steps.

In sub-step 101, a filter is processed in order to separate text item D2 and non-text item D3 on the basis of the number identifying a specific symbol. Then, in sub-step 102, the information of the non-text item D3 is transformed in an intermediate non-text bitmap D5 having a 80×75 intermediate resolution.

In parallel, sub-step 103 is performed on the text item D2 from sub-step 101. The result is the transformation of the text item D2 into a final text bitmap D4 having the target resolution. Sub-step 103 may render the text content of the teletext page in an optimized manner.

Step 200 of the method consists in scaling up the 80×75 intermediate non-text bitmap D5. This operation transforms the intermediate non-text bitmap D5 into a final non-text bitmap D7 having a resolution which is equal to the 400×300 target resolution.

In more details, in this first embodiment, the up-scaling step 200 is based on the use of the luminance information. The initial RGB 80×75 intermediate non-text bitmap D5 is converted into a single luminance plane D9 through sub-step 201. Then the luminance plane D9 is scaled up to the target resolution through sub-step 202 using an advanced up-scaling algorithm.

Such an advanced graphics up-scaling algorithm may be, for example, a polyphase interpolating up-scaling algorithm, a content-adaptive up-scaling algorithm based either on classification of the local image content (such as the DRC scaler of SONY) or on edge-adaptive interpolation (EDDI, NEDI, edge-orientation controlled LTI), a morphological scalar such as “vector erosion”, or any up-scaling algorithms known to skilled in the art.

Finally, at sub-step 203, values of the up-scaled luminance plane D11 are mapped to one of the eight RGB triplets. In order to prevent isolated false colors, which may result from the ambiguity of luminance mapping, a comparison is made with the initial intermediate non-text bitmap D5 during the merging sub-step 203. For example, the constraint that the up-scaled luminance of one pixel has to match with the RGB triplet of one pixel of the initial intermediate non-text bitmap D5 located in the vicinity may be applied.

The final step 300 corresponds to the merging of the up-scaled final non-text bitmap D7 from step 200 and the final text bitmap D4 given as output of sub-step 103 of the separation step 100. Merging step 300 may include algorithms allowing the missing pixel to be filled, or the correct pixel to be selected when there is a double defined pixel. Merging step 300 may also allow imperfections of the output bitmap D to be corrected.

The resulting merged output bitmap D is sent to the display device having the target resolution.

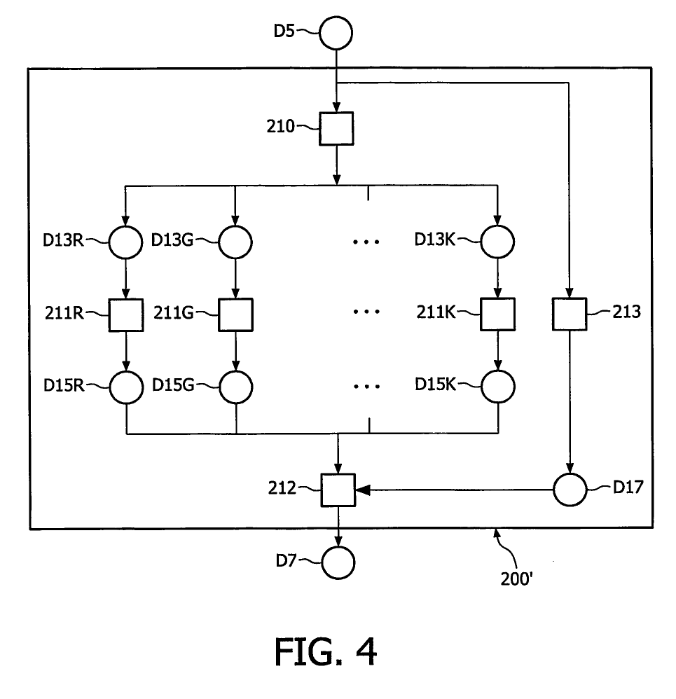

FIG. 4 shows in more details a second embodiment 200′ of the up-scaling step 200 of FIG. 3. In FIG. 4, at sub-step 210, the intermediate non-text bitmap D5 is first separated into eight planes D13R, D13G . . . , each corresponding to one possible color (Red, Green, Blue . . . ). Each plane D13 is then separately up-scaled (sub-steps 211R, 211G . . . ) using an advanced up-scaling algorithm. Results 215R, 215G . . . of each up-scaling sub-step 211 are finally merged in order to build the 400×300 final non-text bitmap D7 through sub-step 212.

At the final merging sub-step 212, another 400×300 additional bitmap D17 is used. This additional bitmap D17 is the result of a simple up-scaling algorithm applied on the intermediate non-text bitmap D5 in sub-step 213. For example this simple up-scaling algorithm is a pixel repetition up-scaling algorithm. This additional bitmap D17 allows the missing pixel to be filled or the correct pixel to be chosen when there is a double defined pixel in the merging sub-step 212.

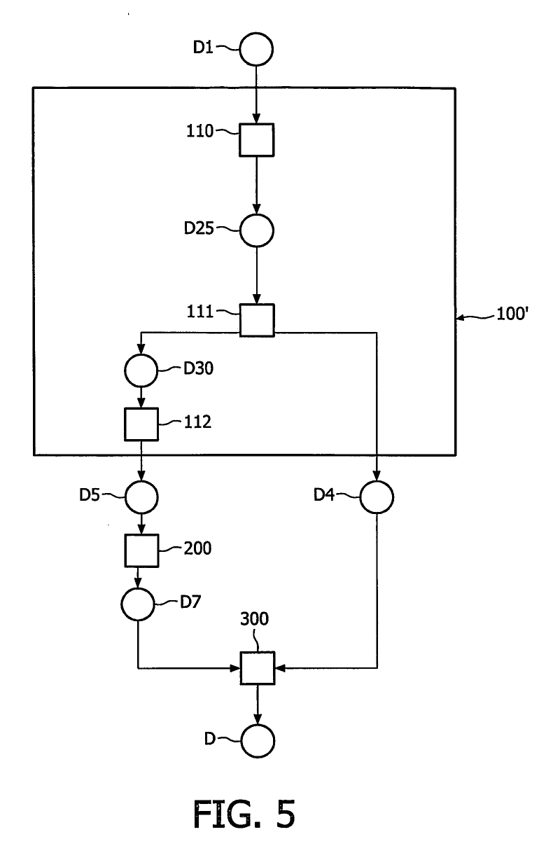

In another embodiment of the method according to the invention depicted in FIG. 5, the first sub-step 110 of the separation step 100′ consists in rendering the teletext page D1 in an initial bitmap D25 having the target resolution. Then, a filter is applied on this 400×300 initial bitmap D25 allowing separation of text bitmap D4 and non-text bitmap D30 (sub-step 111). Such a filter may be based on letter pattern recognition in order to separate text content and graphic content of the bitmap.

At this stage of the method, the non-text bitmap D4 from filter 111 has a resolution of 400×300. It corresponds to the final text bitmap.

Sub-step 112 down-scales the input non-text bitmap D30 in order to give an output of an intermediate non-text bitmap D5 with a 80×75 resolution. Through sub-step 212 no information is lost because, as mentioned in the introduction above, teletext graphics are of a ‘checkerboard’ type, the resolution of which is 80×75.

Then the second step 200 of the method is completed. Advanced up-scaling step 200 is identical to what has been described above. The intermediate non-text bitmap D5 output from sub-step 112 is transformed into a final non-text bitmap D7 having the target resolution.

At the final merging step 300, the final non-text bitmap D7 is merged with the final text bitmap D4 in a similar way as described with reference to FIG. 3. The rendered bitmap D output is sent to the corresponding display device.

Throughout the above description, the word ‘display device’ refers either to a screen or a printer, and more widely to any means allowing display of bitmaps.

The various embodiments described above are provided by way of illustration only and should not be construed as limiting the invention. Those skilled in the art will readily recognise various modifications that can be made to these embodiments without departing from the scope of the present invention, which is set in the following claims.

1. A method for rendering smooth teletext graphics when an input teletext page (D) is to be displayed at a target resolution on a device, characterized in that it comprises the steps of:
separating (100, 100′) non-text information and text information composing the input teletext page in order to give, as output, an intermediate non-text bitmap (D5) at an intermediate resolution and a final text bitmap (D4) at said target resolution;
scaling up (200, 200′) the intermediate non-text bitmap (D5) to obtain a final non-text bitmap (D7) at said target resolution, using an advanced up-scaling algorithm; and,
merging (300) the final non-text bitmap (D7) and the final text bitmap (D4) in order to give an output of a rendered bitmap (D) having the target resolution.

2. A method as claimed in claim 1, characterized in that the step of scaling up (200) said intermediate non-text bitmap (D5) comprises the sub-steps of:
obtaining (201) a luminance plane (D2) from said intermediate non-text bitmap (D5);
scaling up (202) to said target resolution said luminance plane (D9) in order to get an up-scaled luminance plane (D11), using said advanced up-scaling algorithm; and,
mapping (203) each pixel of said up-scaled luminance plane (D11) with one color identifier of a plurality of color identifiers in order to obtain said final non-text bitmap (D7).

3. A method as claimed in claim 2, characterized in that said mapping sub-step (203) uses said intermediate non-text bitmap (D5) as an input for improving the mapping process.

4. A method as claimed in claim 1, characterized in that the step of scaling up (200′) said intermediate non-text bitmap comprises the sub-steps of:
separating (210) said intermediate non-text bitmap (D5) into a plurality of color planes (D13R, D13G . . . );
scaling up (211R, 211G . . . ) separately to said target resolution each color plane (D13R, D13G . . . ) of said plurality of color planes (D15R, D15G . . . ) to obtain a plurality of up-scaled color planes, using said advanced up-scaling algorithm; and,
merging (212) said plurality of up-scaled color planes (D15R, D15G . . . ) in order to obtain said final non-text bitmap (D7).

5. A method as claimed in claim 4, characterized in that it further comprises the sub-step (213) of scaling up classically said intermediate non-text bitmap (D5) in order to obtain a classical up-scaled non-text bitmap (D17) having said target resolution by using a classical up-scaling algorithm based on pixel repetition, and said merging sub-step (212) uses said classical up-scaled non-text bitmap (D17) as an input for improving the merging process.

6. A method as claimed in claim 1, characterized in that said separating step (100) comprises the sub-steps of:
filtering (101) said input teletext page (D1) into a non-text item (D3) and a text item (D2);
rendering (102) said non-text item (D3) into said intermediate non-text bitmap (D5) at said intermediary resolution; and,
rendering (103) said text item (D2) into said final text bitmap (D4) at said target resolution.

7. A method as claimed in claim 1, characterized in that said separating step (100′) comprises the sub-steps of:
converting (110) said input teletext page (D1) into an initial teletext bitmap (D25) having the target resolution;
filtering (111) said initial teletext bitmap (D25) into an initial non-text bitmap (D30) and a final text bitmap (D4); and,
downscaling (112) said initial non-text bitmap (D30) from said target resolution to said intermediate resolution in order to give an output of said intermediate non-text bitmap (D5).

8. An apparatus for rendering smooth teletext graphics when an input teletext page (D1) is to be displayed at a target resolution on a device, characterized in that it comprises:
separation means (100, 100′) for separating the input teletext page (D1) into an intermediate non-text bitmap (D5) at an intermediate resolution and a final text bitmap (D4) at said target resolution;
up-scaling means (200, 200′), using an advanced up-scaling algorithm for scaling up said intermediate non-text bitmap (D5) from the intermediate resolution to said target resolution, and giving an output of a final non-text bitmap (D7);
merging means (300) for merging said final non-text bitmap (D7) from said up-scaling means (200, 200′) with said final text bitmap (D4) from said separation means (100, 100′) in order to give an output of a rendered bitmap (D) at said target resolution.

9. An apparatus as claimed in claim 8, characterized in that said up-scaling means (200) comprises:
luminance means (201) for obtaining a luminance plane (D9) from said intermediate non-text bitmap (D5);
advanced up-scaling means (202), based on an advanced up-scaling algorithm for up-scaling to said target resolution said luminance plane (D9) given by said luminance means (201); and,
mapping means (203) for mapping each pixel of the up-scaled luminance plane (D11) given by said advanced up-scaling means (202) with one color identifier of a plurality of color identifiers in order to obtain said final non-text bitmap (D7).

10. An apparatus as claimed in claim 8, characterized in that the up-scaling means (200′) comprises:
color separation means (210) for separating said intermediate non-text bitmap (D5) into a plurality of color planes (D13R, D13G . . . );
advanced up-scaling means (211R, 211G . . . ) based on an advanced up-scaling algorithm for separately up-scaling to said target resolution each color plane of said plurality of color planes (D13R, D13G . . . ); and,
merging means (212) allowing merging of the plurality of up-scaled color planes (D15R, D15G . . . ) given by said advanced up-scaling means (211r, 211G . . . ) to calculate said final non-text bitmap (D7).
